(19) United States
(12) Patent Application Publication
(10) Pub. No.: US 2023/0278241 A1
(43) Pub. Date: Sep. 7, 2023

(54) Knives and Other Tools and Devices Incorporating Cutting Chains

(71) Applicant: Chain Orthopedics, LLC, Bogota, NJ (US)

(72) Inventors: Paul VIOLA, Bogota, NJ (US); Richard Thomas BRIGANTI, Bala Cynwyd, PA (US); Timothy J. LANGLOSS, Berwyn, PA (US)

(73) Assignee: Chain Orthopedics, LLC, Bogota, NJ (US)

(21) Appl. No.: 18/102,910

(22) Filed: Jan. 30, 2023

Related U.S. Application Data
(60) Provisional application No. 63/305,469, filed on Feb. 1, 2022.

(51) Int. Cl. B26B 11/00; B26B 23/00; B23D 57/02

(52) U.S. Cl. CPC B26B 11/00; B23D 57/023; B26B 23/00

(57) ABSTRACT

Tools and other devices incorporating cutting chains are disclosed. In some examples, a knife comprises a chain of cutting links positioned along a chain path around a saw bar having a rail, wherein each of the cutting links comprises a groove such that the cutting links straddle the rail of the saw bar. In some examples, a knife comprises a chain of cutting links and a plurality of motors for driving the chain of cutting links. In some examples, a knife comprises a chain of cutting links driven along a blunt edge of the knife. In other examples, the tool is an axe, hatchet, or other device.

### CROSS-REFERENCE TO RELATED APPLICATIONS

This application claims priority to U.S. Provisional Pat. Application No. 63/305,469, filed Feb. 1, 2022, entitled “Knives and Other Tools and Devices Incorporating Cutting Chains,” the entire contents of which is incorporated herein by reference.

This application is also related to U.S. Provisional Pat. Application No. 63/058,216, filed Jul. 29, 2020, entitled “Thin Single Width Chain Saw,” U.S. Provisional Pat. Application No. 63/085,290, filed Sep. 30, 2020, entitled “Thin Single Width Chain Saw,” U.S. Provisional Pat. Application No. 63/147,033, filed Feb. 8, 2021, entitled “Chain Saws and Components for Chain Saws,” U.S. Provisional Pat. Application No. 63/154,367, filed Feb. 26, 2021, entitled “Cutting Guide Systems,” U.S. Provisional Pat. Application No. 63/154,379, filed Feb. 26, 2021, entitled “Systems and Methods for Manufacturing Saws and Saw Components,” U.S. Provisional Pat. Application No. 63/195,994, filed Jun. 2, 2021, entitled “Cutting Guide Systems and Methods,” U.S. Provisional Pat. Application No. 63/209,525, filed Jun. 11, 2021, entitled “Devices for Maintaining Tension in Chain Saws,” U.S. Provisional Pat. Application No. 63/209,540, filed Jun. 11, 2021, entitled “Systems for Robotic Surgery,” U.S. Non-Provisional Pat. Application No. 17/443,646, filed Jul. 27, 2021, entitled “Chain Saws, Components for Chain Saws, and Systems for Operating Saws,” International Application No. PCT/US2021/043433, filed Jul. 28, 2021, entitled “Chain Saws, Components for Chain Saws, and Systems for Operating Saws,” U.S. Provisional Pat. Application No. 63/305,422, filed Feb. 1, 2022, entitled “Devices for Maintaining Tension in Chain Saws,” U.S. Non-Provisional Pat. Application No. 17/590,192, filed Feb. 1, 2022, entitled “Cutting Guide Systems and Methods,” International Application No. PCT/US2022/014679, filed Feb. 1, 2022, entitled “Cutting Guide Systems and Methods,” U.S. Non-Provisional Pat. Application No. 17/741,734, filed May 11, 2022, entitled “Devices for Maintaining Tension in Chain Saws,” and International Application No. PCT/US2022/028792, filed May 11, 2022, entitled “Devices for Maintaining Tension in Chain Saws.” The entire contents of these applications are incorporated herein by reference.

### TECHNICAL FIELD

The present disclosure is directed to knives and other tools and devices incorporating cutting chains.

### BACKGROUND

Various tools and other devices are known for performing tasks in various fields, such as construction, landscaping, hunting, food processing, self-defense, and weaponry, among others.

U.S. Pat. No. 9,616,512 to Viola discloses a chain saw which may be used, for example, for cutting bone. The disclosure of U.S. Pat. No. 9,616,512 is hereby incorporated by reference herein in its entirety. U.S. Provisional Pat. Application No. 63/058,216, filed Jul. 29, 2020, entitled “Thin Single Width Chain Saw,” U.S. Provisional Pat. Application No. 63/085,290, filed Sep. 30, 2020, entitled “Thin Single Width Chain Saw,” U.S. Provisional Pat. Application No. 63/147,033, filed Feb. 8, 2021, entitled “Chain Saws and Components for Chain Saws,” U.S. Provisional Pat. Application No. 63/154,367, filed Feb. 26, 2021, entitled “Cutting Guide Systems,” U.S. Provisional Pat. Application No. 63/154,379, filed Feb. 26, 2021, entitled “Systems and Methods for Manufacturing Saws and Saw Components,” U.S. Provisional Pat. Application No. 63/195,994, filed Jun. 2, 2021, entitled “Cutting Guide Systems and Methods,” U.S. Provisional Pat. Application No. 63/209,525, filed Jun. 11, 2021, entitled “Devices for Maintaining Tension in Chain Saws,” U.S. Provisional Pat. Application No. 63/209,540, filed Jun. 11, 2021, entitled “Systems for Robotic Surgery,” U.S. Non-Provisional Pat. Application No. 17/443,646, filed Jul. 27, 2021, entitled “Chain Saws, Components for Chain Saws, and Systems for Operating Saws,” International Application No. PCT/US2021/043433, filed Jul. 28, 2021, entitled “Chain Saws, Components for Chain Saws, and Systems for Operating Saws,” U.S. Provisional Pat. Application No. 63/305,422, filed Feb. 1, 2022, entitled “Devices for Maintaining Tension in Chain Saws,” U.S. Non-Provisional Pat. Application No. 17/590,192, filed Feb. 1, 2022, entitled “Cutting Guide Systems and Methods,” International Application No. PCT/US2022/014679, filed Feb. 1, 2022, entitled “Cutting Guide Systems and Methods,” U.S. Non-Provisional Pat. Application No. 17/741,734, filed May 11, 2022, entitled “Devices for Maintaining Tension in Chain Saws,” and International Application No. PCT/US2022/028792, filed May 11, 2022, entitled “Devices for Maintaining Tension in Chain Saws,” the disclosures of which are incorporated by reference herein in their entirety, disclose chain saws, components for chain saws, cutting guide systems for chain saws, methods of making chain saws and components, and methods of using chain saws and components.

### SUMMARY

The present disclosure is directed to knives and other tools and devices incorporating cutting chains.

In some examples, a knife comprises a handle comprising a housing, a knife blade extending from the handle, and a chain of cutting links, wherein the knife further comprises a plurality of motors for driving the chain of cutting links. The plurality of motors may be located in the handle.

In some examples, a knife comprises a handle comprising a housing, a knife blade extending from the handle, wherein the knife blade comprises a cutting edge and a blunt edge, a chain of cutting links, and at least one motor for driving the chain of cutting links, wherein the chain of cutting links is mounted to be driven along the blunt edge of the knife blade. The knife may comprise a plurality of motors for driving the chain of cutting links. The motor(s) may be located in the handle.

In some examples, a handheld tool comprises a handle comprising a housing, a first tool component extending from the handle, a chain of cutting links, and one or more motors for driving the chain of cutting links. The handheld tool may be a knife, and the first tool component may be a knife blade. The handheld tool may be an axe, and the first tool component may be an axe head. The handheld tool may be a hatchet, and the first tool component may be a hatchet head. The handheld tool may be a fist-held device, and the first tool component may be one or more loops (e.g., a set of rings or a single elongated ring forming an open slot) adapted to receive fingers of a user. The motor(s) may be located in the handle.

In some examples, a handheld tool comprises a handle comprising a housing, a head extending from the handle, wherein the head comprises a cutting edge and a blunt edge, a chain of cutting links, and at least one motor for driving the chain of cutting links, wherein the chain of cutting links is mounted to be driven along the blunt edge of the head. The handheld tool may be an axe, and the head may be an axe head. The handheld tool may be a hatchet, and the head may be a hatchet head. The tool may comprise one or more motors for driving the chain of cutting links. The motor(s) may be located in the handle.

In some examples, a fist-held device comprises a handle comprising a housing adapted to be held in a fist of a user, one or more loops (e.g., a set of rings or a single elongated ring forming an open slot) adapted to receive fingers of the user, a chain of cutting links, and at least one motor for driving the chain of cutting links. The chain of cutting links may extend around the one or more loops.

Further examples and features of embodiments of the invention will be evident from the drawings and detailed description.

### BRIEF DESCRIPTION OF THE DRAWINGS

The accompanying drawings illustrate examples of devices, components, and methods disclosed herein and, together with the description, serve to explain the principles of the present disclosure.

FIG. 1 shows a first example of a tool in the form of a knife with a chain of cutting links.

FIG. 2 shows the knife of FIG. 1 with the housing of the handle removed.

FIG. 3 shows the knife of FIG. 1 with parts removed to show details of a chain saw and drive mechanism.

FIG. 4 shows another view of the drive mechanism of the knife of FIG. 1.

FIG. 5 shows view similar to FIG. 4 but with a motor cover removed.

FIG. 6 shows a view of part of the drive mechanism of the knife of FIG. 1.

FIG. 7 shows another view of part of the drive mechanism of the knife of FIG. 1.

FIG. 8 shows another example of a tool in the form of a knife with a chain of cutting links.

FIG. 9 shows a side view of another example of a tool in the form of a knife with a chain of cutting links.

FIG. 10 shows a perspective view of the knife of FIG. 9.

FIG. 11 shows an exploded view of the knife of FIG. 9.

FIG. 12 shows a side view of another example of a tool in the form of a knife with a chain of cutting links.

FIG. 13 shows a perspective view of the knife of FIG. 12.

FIG. 14 shows an exploded view of the knife of FIG. 12.

FIG. 15 shows an example of a chain saw cartridge in accordance with the disclosure.

FIG. 16 shows a single link for a cutting chain of a chain saw such as the cutting chain of the chain saw cartridge in FIG. 15.

FIG. 17 shows a schematic view of a layout of cutting teeth of a link.

FIG. 18A shows an example of a saw bar that may be used in a chain saw in accordance with the disclosure.

FIG. 18B shows an alternative example of a saw bar that may be used in a chain saw in accordance with the disclosure.

FIG. 19A shows an enlarged view of the saw bar of FIG. 18A, with a chain of links assembled on the bar, in a partial cut-away view.

FIG. 19B shows an enlarged end view of the saw bar of FIG. 18A at the distal end of the bar, with a single link shown.

FIG. 19C is an enlarged view of a portion of FIG. 19B.

The accompanying drawings may be better understood by reference to the following detailed description.

### DETAILED DESCRIPTION

For the purposes of promoting an understanding of the principles of the disclosure, reference will now be made to the examples illustrated in the drawings, and specific language will be used to describe those and other examples. It will nevertheless be understood that no limitation of the scope of the claims is intended by the examples shown in the drawings or described herein. Any alterations and further modifications to the illustrated or described systems, devices, components, or methods, and any further application of the principles of the present disclosure, are fully contemplated as would normally occur to one skilled in the art to which the disclosure relates. In particular, the features, components, and/or steps described with respect to one implementation of the disclosure may be combined with features, components, and/or steps described with respect to other implementations of the disclosure.

The designations “first” and “second” as used herein are not meant to indicate or imply any particular positioning or other characteristic. Rather, when the designations “first” and “second” are used herein, they are used only to distinguish one component or part from another. The terms “attached,” “connected,” “coupled,” and the like mean attachment, connection, coupling, etc., of one part to another either directly or indirectly through one or more other parts, unless direct or indirect attachment, connection, coupling, etc., is specified. The term “user” refers to one or more persons using the devices, systems, and/or methods described herein, such as one or more surgeons, physicians, operators, or other persons using the devices, systems, and/or methods.

U.S. Pat. No. 9,616,512, U.S. Provisional Pat. Application No. 63/147,033, U.S. Non-Provisional Pat. Application No. 17/443,646, and International Application No. PCT/US2021/043433 describe and illustrate examples of types of chain saws that may be used with devices as disclosed herein.

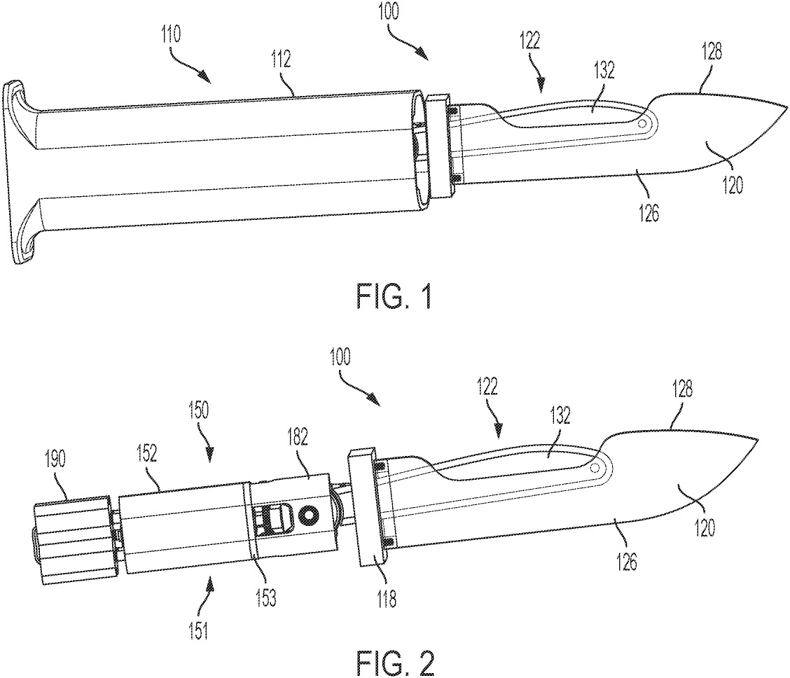

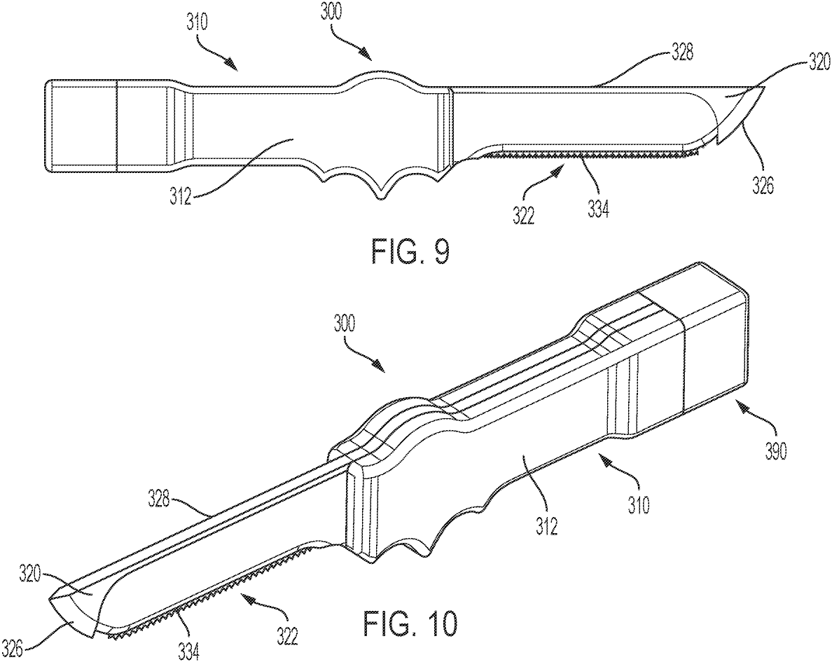

FIG. 1 shows a first example of a tool 100 in the form of a knife with a chain of cutting links. The chain is not shown in FIG. 1 but may be similar to chains 334, 434 (described below in relation to FIGS. 9-14) any may extends around saw bar 132 similar to the manner in which chains 334, 434 extend around saw bars 332, 432 (described below).

As shown in FIG. 1, the knife 100 comprises a handle 110 comprising a housing 112. The handle 110 is adapted to be held in the hand of a user, like an ordinary knife. A knife blade 120 extends from a cross piece 118 to which the housing 112 may be attached, thereby attaching the knife blade 120 to the housing 112. The knife blade 120 includes a sharp cutting edge 126 and a blunt edge 128. The knife blade 120 is illustrated as transparent in FIGS. 1 and 2 in order to reveal the saw bar 132, which is housed inside the knife blade 120. The knife blade 120 has a hollow interior for accommodating the saw bar 132. The knife blade 120 has an opening 122 along its blunt edge 128 through which a portion of the chain of links around the saw bar 132 is exposed.

The knife blade 120 may be any suitable size and shape for the desired application. For example, the size and shape may be similar to a standard tactical or survival knife (e.g., similar to a Ka-Bar knife).

FIG. 2 shows the knife 100 with the housing of the handle removed. FIG. 2 shows a drive mechanism 150 for driving the chain as well as a battery unit 190 that provides power to the drive mechanism 150. In the knife 100 of FIG. 1, when the knife 100 is assembled, the drive mechanism 150 may be housed within the housing 112. Optionally, the battery unit 190 may be housed within the housing 112 or may be part of or constitute a separate unit attachable to the knife 100 externally to the housing 112. The battery unit 190 may comprise a single battery or multiple batteries. Additionally or alternatively, the knife 100 may be operable using AC power, e.g., by an AC power adapter attachable to the knife 100.

Referring again to FIG. 1, the handle 110 provides an enclosure. The size, shape, material, texture, color, etc., of the handle 110 may be tailored to the desired application. The handle 110 may aid in styling, grip endurance, waterproofing, shock-resistance, etc., and may provide a compartment for the battery unit 190. One or more switches or controls may be placed on the housing 110 for, e.g., turning the chain on and off, varying the speed, etc. The knife 100 may also include a safety lock to make sure that the chain is not accidentally powered. The knife 110 may also include battery charging and/or a battery output to make external use of the battery unit 190. For example, a battery output may be included to allow a user to charge a cell phone, etc.

In addition, the knife 110 and other tools disclosed herein may include a mechanism for charging the battery of the tool when the tool is placed in or on a holder or charging station. Such charging may be through wireless or wired charging. In one example, the knife or other tool has contacts such that if the knife or other tool is put into a tool holder such as a sheath (e.g., on a user’s belt), one or more additional batteries connected to the tool holder (e.g., sheath) would charge the battery unit of the tool (e.g., battery unit 190 of knife 100). The additional battery or batteries may be on or in the tool holder (e.g., sheath), on or in a belt holding the tool holder, or on or in a backpack, fanny pack, vest, or other garment or accessory. Additionally or alternatively, the system may include a counterweight to drive a generator that produces electricity as the user is walking, e.g., while hunting (this may be a similar mechanism to the way that a self-winding watch loads the mainspring). This electricity may be used to charge the knife or other tool.

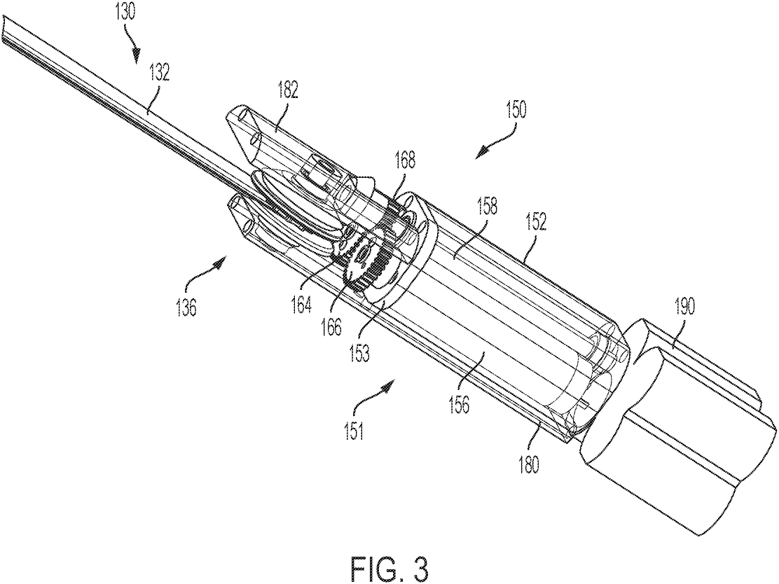

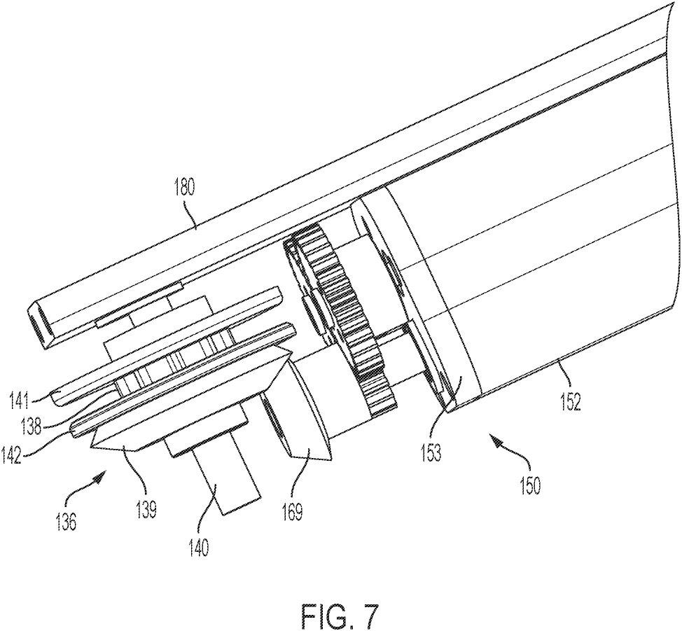

FIG. 3 shows the knife 100 with parts removed to show details of a chain saw 130 and drive mechanism 150. The chain saw 130 includes the saw bar 132, a drive cog assembly 136, and the chain of cutting links. The drive cog assembly 136 includes a drive cog 138 (see FIG. 7). A motor cover 152, support 180, and bracket 182 are illustrated as transparent in FIG. 3 to shown components that would otherwise be blocked from view.

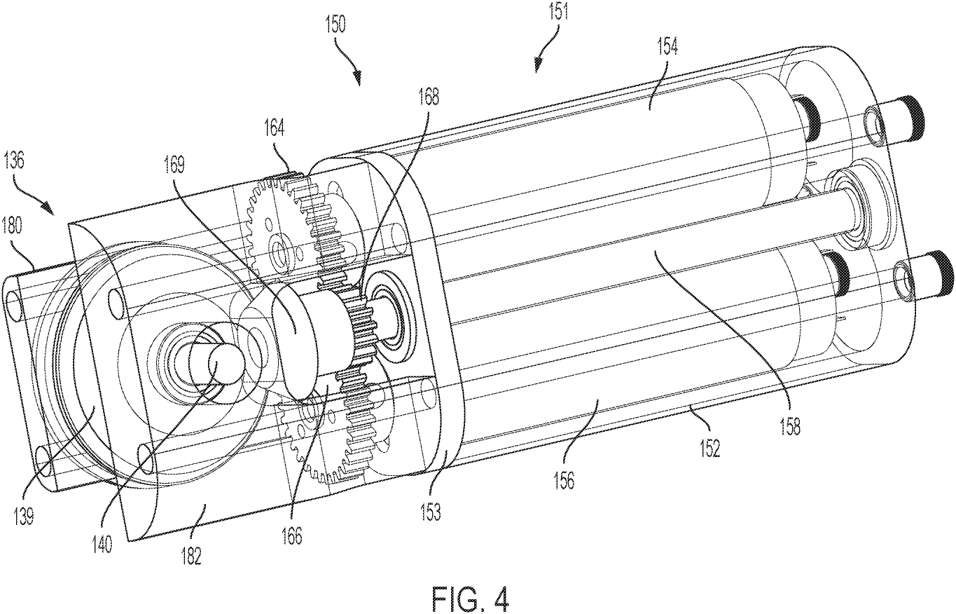

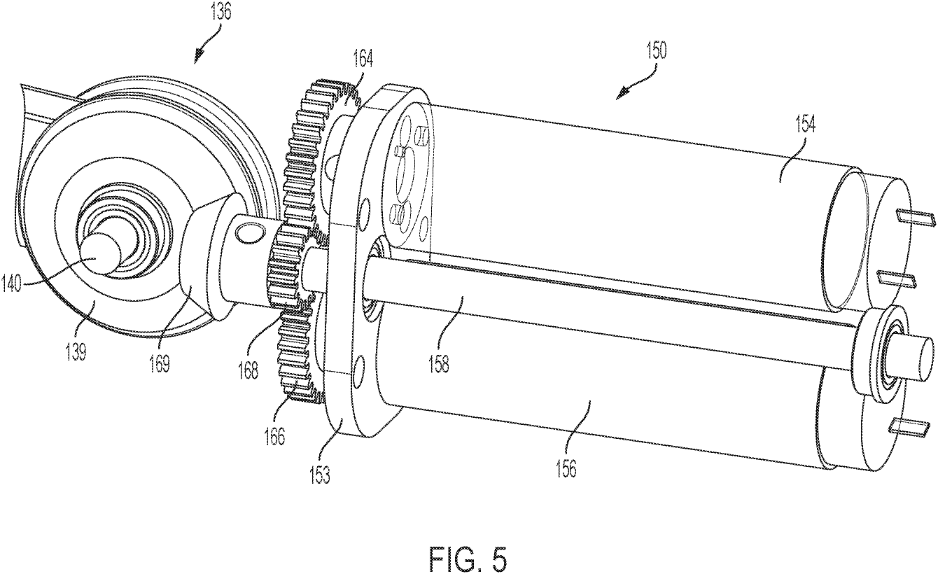

FIG. 4 shows another view of the drive mechanism 150. As with FIG. 3, the motor cover 152, support 180, and bracket 182 are illustrated as transparent in FIG. 4 to shown components that would otherwise be blocked from view. FIG. 5 shows a view similar to FIG. 4 but with the motor cover 152, support 180, and bracket 182 removed.

As can be seen in FIGS. 4 and 5, the drive mechanism 150 comprises a dual motor configuration, with a first motor 154 and a second motor 156. When the knife 100 is assembled, the motors 154, 156 are located in the handle 110. The two motors 154, 156 drive a single drive shaft 158 through a set of gears 164, 166, 168. The two motors 154, 156 are electric motors that produce rotary motion rotating the respective gears 164, 166. The gears 164, 166 engage gear 168 connected to drive shaft 158 such that operation of the motors 154, 156 and rotation of the gears 164, 166 causes rotation of the gear 168 and, consequently, the drive shaft 158. Rotation of the drive shaft 158 causes rotation of a drive gear 169. In an alternative configuration, the gear 168 may rotate around a fixed drive shaft 158, and the gear 168 may be connected directly to, or may be integral with, the drive gear 169, such that rotation of the gear 168 causes rotation of the drive gear 169. The illustrated drive gear 169 is a bevel gear with teeth that engage teeth of saw gear 139, which is also a bevel gear (the teeth of gears 169, 139 are not shown, but their engaging beveled surfaces where the teeth are located are shown). The saw gear 139 is part of or connected to the drive cog assembly 136, including the drive cog 138 around which the chain is engaged (via teeth of the drive cog 138). Rotation of the drive gear 169 causes rotation of the saw gear 139 and, consequently, rotation of the drive cog 138 of the chain saw 130, thereby driving the chain of cutting links. Thus, the plurality of motors 154, 156 drives the chain of cutting links.

While one motor may be used, the use of a plurality of motors has advantages over the use of just a single motor. With two motors, the cross-sectional profile is more conducive to the general shape of a knife where the height is taller than the width. The use of multiple motors with smaller diameters, as compared to a single motor with a larger diameter, results in a knife handle that is more ergonomic. Another advantage is that if one motor fails the second motor can continue driving the knife. The knife may include a clutch mechanism such that if the failed motor froze or jammed, the functioning motor would still drive the chain. Another advantage of multiple motors as compared to one motor is that multiple motors result in more surface area for heat dispersion. Heat dispersion may be accomplished by having a heatsink in contact with both motor cylinders using conduction, convection, and/or radiation to disperse heat. Heat could be detrimental to the life and reliability of the motors. Another advantage of multiple motors as compared to one motor is that the operator can choose to energize only one motor in a low power requirement situation, extending battery life. The knife may include a torque monitoring or speed monitoring system that automatically controls the amount of power, volts, and/or amps to each motor (including, e.g., shutting down one motor) in order to achieve the desired chain power or speed. In other examples, the knife may have more than two motors, with similar advantages.

The drive mechanism 150 includes a housing 151 comprising the motor cover 152 and a plate 153. The motors 154, 156 may be mounted at one end to the motor cover 152 and at the other end to the plate 153. For example, fixed collars of the motors 154, 156 may be press fit into a registering or alignment bore of the plate 153 which is concentric to the axis of the respective motor. Fasteners may be used to fix the motors 154, 156 to the plate 153. Holes are visible to accommodate fasteners (e.g., flathead screws) for fastening the motors 154, 156. The drive shafts of the motor 154, 156 extend on the other side of the plate 153 to drive the gears 164, 166, respectively. Similarly, the drive shaft 158 may be mounted at one end to the motor cover 152, while at the other end the drive shaft may extend through the plate 153. At locations where a rotating shaft is mounted to or extends through a fixed part (e.g., drive shaft 158 mounted to motor cover 152 or extending through plate 153), suitable bearings or bushings may be used to permit rotation while maintaining a fixed centerline of rotation. Thus, the drive mechanism housing 151 (motor cover 152 and plate 153) locates the cylindrical motors 154, 156, maintaining a centerline-to-centerline distance of their drive shafts with respect to the drive shaft 158. In addition, the plate 153 controls the location of the gear 168 and resists the side thrust produced by the beveled gear assembly (drive gear 169 and saw gear 139). Clips, bushings, and/or spacers may be used to locate the drive shaft 158 axially.

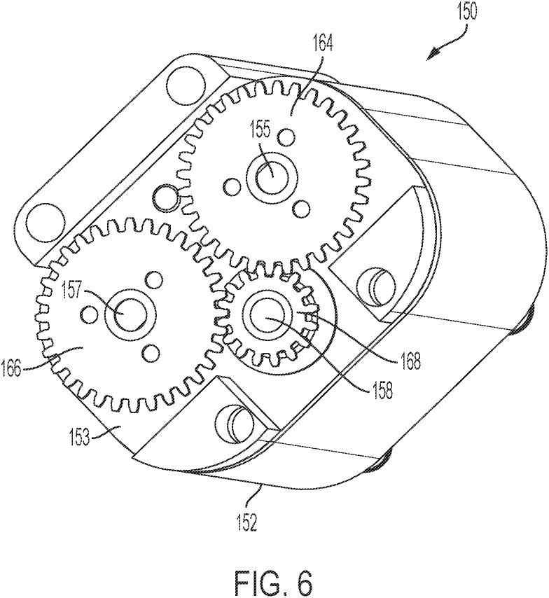

FIG. 6 shows a view of part of the drive mechanism 150 of the knife 100. The gears 164, 166 are attached to motor drive shafts 155, 157, respectively, of the electric motors 154, 156. Each gear 164, 166 may be attached to its respective motor drive shaft 155, 157 by an adapter hub with a set screw that engages a flat surface of the motor drive shaft 155, 157 to lock the gear 164, 166 to its respective motor drive shaft 155, 157. The gears 164, 166 both drive the gear 168. The gear 168 is attached directly to the beveled drive gear 169 via the drive shaft 158.

FIG. 7 shows another view of part of the drive mechanism 150 of the knife 100, with the bracket 182 removed. As can be seen in FIGS. 3 and 4, the bracket 182 supports the drive cog shaft 140. The other end of the drive cog shaft 140 is supported by the support 180. As can be seen in FIG. 7, the drive cog assembly 136 includes a drive cog 138 having teeth for engaging with the chain of the chain saw 130. The drive cog assembly 130 includes a first flange 141 and a second flange 142 that can help to resist lateral disassociation of the links and to position the saw bar 132.

Referring again to FIG. 2, it can be seen that there is a general gradual exposure of the saw bar 132 at the opening 122 of the knife blade 120 so that the user has freedom to have a depth of cut. The knife 100 may include a chamfer for a smooth transition between the surface of the saw bar 132 and the knife blade 120 at the opening 122 so that if one was to cut an object (e.g., bone or a branch), it would not be stopped by the blunt edge of the knife blade on either side of the chain. That is, the thickness of the knife blade material may be narrowed (chamfered, tapered, angled) at the area of the opening 122 on both sides of the saw bar. As the chain is cutting and advancing into the object to be cut, when the knife blade material on either side of the chain reaches the object to be cut, the chamfer facilitates spreading of the material being cut and assists in the knife continuing to advance into the object being cut.

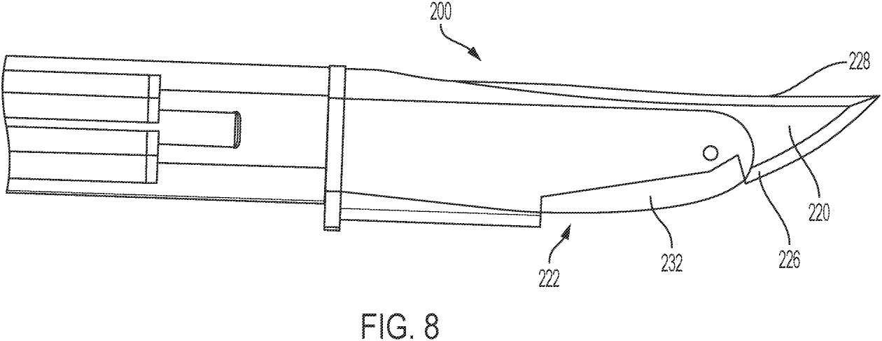

FIG. 8 shows another example of a tool 200 in the form of a knife with a chain of cutting links. The chain is not shown in FIG. 8 but may be similar to chains 334, 434 (described below in relation to FIGS. 9-14) any may extends around saw bar 232 similar to the manner in which chains 334, 434 extend around saw bars 332, 432 (described below).

The knife 200 has a sharp cutting edge 226 and a blunt edge 228. The mechanism of knife 200 may be the same as knife 100 except that in knife 200 the knife blade 220 has an opening 222 along its sharp cutting edge 226 through which a portion of the chain of links around the saw bar 232 is exposed (instead of along the blunt edge as in knife 100), and the opening 222 is located more distally than the opening 122.

One advantage to the knife 100 shown in FIG. 1 as compared to the knife 200 shown in FIG. 8 is that the knife 100 can be operated as a standard knife, with a continuous cutting edge. For example, the knife 100 may be used as a standard knife in situations in which the user wants to conserve battery life or for silent operation, or if there is a failure in the chain saw mechanism or a rundown battery condition.

As another alternative design, the knife 100 or 200 may have a double sharp edge. For example, the edge 128 in FIG. 1 or the edge 228 in FIG. 8 may be a sharp edge instead of a blunt edge.

As can be seen by a comparison of FIGS. 1 and 8, the opening in the knife blade for the chain of the chain saw may be more distal. Such a positioning may facilitate a cutting and traction so that once the knife initially pierces an object to be cut, the chain can pull or draw the knife into the object that is being cut. The chain may also be used for a lateral motion (e.g., while hunting, to cut the bone of a deer or elk). As one example use, with certain knives as disclosed herein, the knife blade may be used to cut soft tissue, while the chain saw may be used to cut the hard tissue/bone. The knife may include a force transducer and/or electronic circuit wherein when the user pulls the knife to withdraw it from an object being cut, the chain saw would reverse direction of the chain to facilitate removal of the knife.

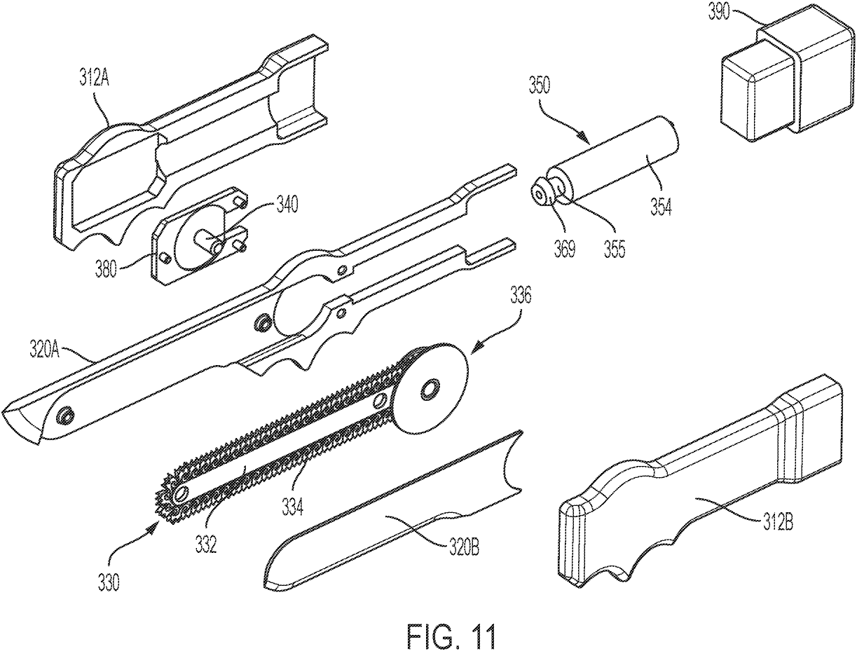

FIG. 9 shows a side view of another example of a tool 300 in the form of a knife with a chain 334 of cutting links. FIG. 10 shows a perspective view of the knife 300. FIG. 11 shows an exploded view of the knife 300.

The knife 300 is similar to the knives 100, 200 and may incorporate features as described above with respect to the knives 100, 200. The knife 300 comprises a handle 310 comprising a housing 312. As with knives 100, 200, the handle 310 is adapted to be held in the hand of a user, like an ordinary knife. A knife blade 320 is attached to the handle 310. The knife blade 320 includes a sharp cutting edge 326 and a blunt edge 328. The knife blade 320 has a hollow interior for accommodating the saw bar 332. The knife blade 320 may be in multiple parts 320A, 320B that may be fastened together. The knife blade 320 has an opening 322 through which a portion of the chain 334 of links around the saw bar 332 is exposed. In knife 300, the opening 322 is along the sharp edge 326 of the knife blade 320. In knife 400 (described below), the opening 422 is along the blunt edge 428 of the knife blade 420.

The knife 300 includes a drive mechanism 350 for driving the chain 334 as well as a battery unit 390 that provides power to the drive mechanism 350. When the knife 300 is assembled, the drive mechanism 350 may be housed within the housing 312. Optionally, the battery unit 390 may be housed within the housing 312 or may be part of or constitute a separate unit attachable to the knife 300 externally to the housing 312. The battery unit 390 may comprise a single battery or multiple batteries. Additionally or alternatively, the knife 300 may be operable using AC power, e.g., by an AC power adapter attachable to the knife 300.

The handle 310 provides an enclosure. The housing 312 may be in multiple parts 312A, 312B that may be fastened together. The design and/or switches/controls for the handle 310 may be selected as described above with respect to handle 110. The battery and charging options (e.g., sheath charging) as described above may be used with knife 300.

The chain saw 330 includes the saw bar 332, a drive cog assembly 336, and the chain 334 of cutting links. The drive cog assembly 336 may be similar to the drive cog assembly 136 described above. A bracket 380 may be used to position the chain saw 330 and to provide a drive cog shaft 340.

In the example of knife 300, the drive mechanism 350 comprises a single motor configuration, with a motor 354 located in handle 310. The motor 354 drives a drive shaft 355 which rotates a drive gear 369. The illustrated drive gear 369 is a bevel gear with teeth that engage teeth of a saw gear, similar to the saw gear 139 described above. The saw gear is part of or connected to the drive cog assembly 336. Rotation of the drive gear 369 causes rotation of the saw gear and, consequently, rotation of the drive cog of the chain saw 330, thereby driving the chain 334 of cutting links. Thus, the motor 354 drives the chain 334 of cutting links.

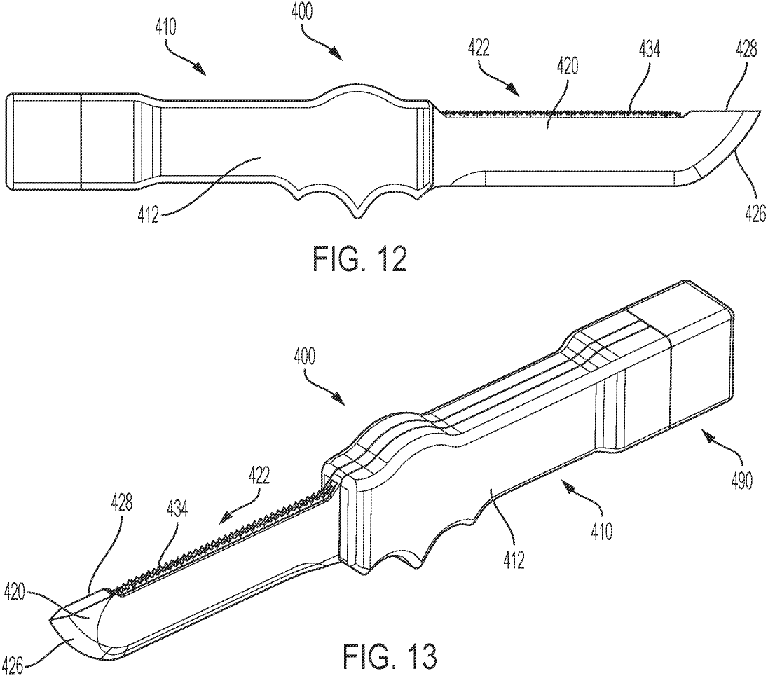

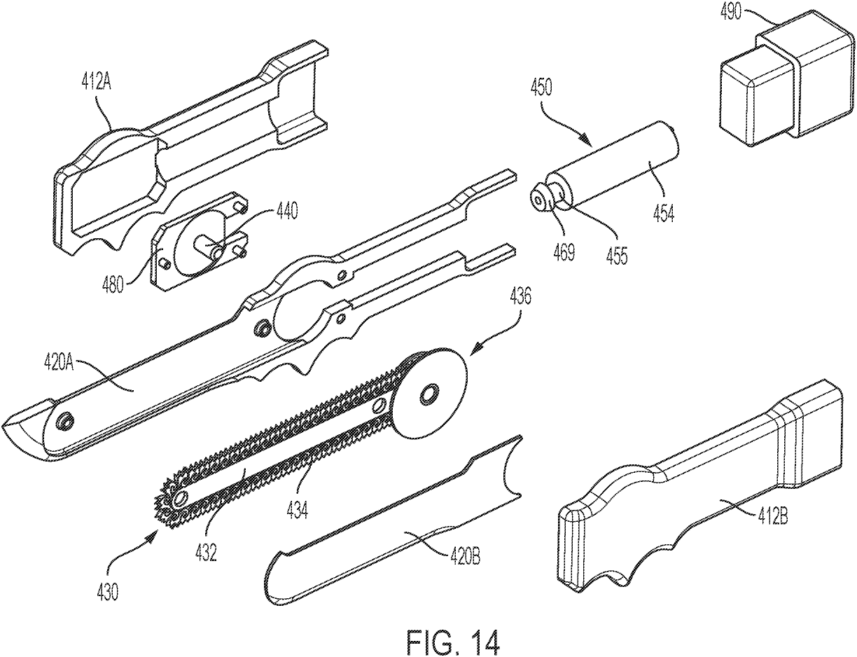

FIG. 12 shows a side view of another example of a tool 400 in the form of a knife with a chain 434 of cutting links. FIG. 13 shows a perspective view of the knife 400. FIG. 14 shows an exploded view of the knife 400.

The knife 400 is similar to the knives 100, 200, 300 and may incorporate features as described above with respect to the knives 100, 200, 300. The knife 400 comprises a handle 410 comprising a housing 412. As with knives 100, 200, 300, the handle 410 is adapted to be held in the hand of a user, like an ordinary knife. A knife blade 420 is attached to the handle 410. The knife blade 420 includes a sharp cutting edge 426 and a blunt edge 428. The knife blade 420 has a hollow interior for accommodating the saw bar 432. The knife blade 420 may be in multiple parts 420A, 420B that may be fastened together. The knife blade 420 has an opening 422 through which a portion of the chain 434 of links around the saw bar 432 is exposed. In knife 400, the opening 422 is along the blunt edge 428 of the knife blade 420.

The knife 400 includes a drive mechanism 450 for driving the chain 434 as well as a battery unit 490 that provides power to the drive mechanism 450. When the knife 400 is assembled, the drive mechanism 450 may be housed within the housing 412. Optionally, the battery unit 490 may be housed within the housing 412 or may be part of or constitute a separate unit attachable to the knife 400 externally to the housing 412. The battery unit 490 may comprise a single battery or multiple batteries. Additionally or alternatively, the knife 400 may be operable using AC power, e.g., by an AC power adapter attachable to the knife 400.

The handle 410 provides an enclosure. The housing 412 may be in multiple parts 412A, 412B that may be fastened together. The design and/or switches/controls for the handle 410 may be selected as described above with respect to handle 110. The battery and charging options (e.g., sheath charging) as described above may be used with knife 400.

The chain saw 430 includes the saw bar 432, a drive cog assembly 436, and the chain 434 of cutting links. The drive cog assembly 436 may be similar to the drive cog assembly 136 described above. A bracket 480 may be used to position the chain saw 430 and to provide a drive cog shaft 440.

As in the knife 300, the drive mechanism 450 comprises a single motor 454 located in the handle 410. The motor 454 drives a drive shaft 455 which rotates a drive gear 469. The illustrated drive gear 469 is a bevel gear with teeth that engage teeth of a saw gear, similar to the saw gear 139 described above. The saw gear is part of or connected to the drive cog assembly 436. Rotation of the drive gear 469 causes rotation of the saw gear and, consequently, rotation of the drive cog of the chain saw 430, thereby driving the chain 434 of cutting links. Thus, the motor 454 drives the chain 434 of cutting links.

While the tools 100, 200, 300, 400 are knives, other handheld tools may incorporate chain saws consistent with the disclosure. Such handheld tools can be held and used easily with one or two hands.

The tools may have a handle comprising a housing, a first tool component extending from the handle, and a chain of cutting links. In the example of tools 100, 200, 300, 400, the handheld tool is a knife, and the first tool component is a knife blade. In other examples, the handheld tool is an axe, and the first tool component is an axe head. In other examples, the handheld tool is a hatchet, and the first tool component is a hatchet head. In other examples, the handheld tool is a fist-held self-defense tool (such as brass knuckles), and the first tool component is one or more loops (e.g., a set of rings or a single elongated ring forming an open slot) adapted to receive fingers of a user. One or a plurality of motors may be located in the handle of the tool.

In the example of tools such as an axe or hatchet, the tool may have a head extending from the handle, wherein the head comprises a sharp cutting edge and a blunt edge, or multiple sharp edges. The chain of cutting links may be mounted to be driven along the blunt edge of the head. In alternative examples, the chain of cutting links may be mounted to be driven along a sharp cutting edge of the head.

In the example of a fist-held device (such as brass knuckles), the tool may have a handle comprising a housing adapted to be held in a fist of a user and one or more loops (e.g., a set of rings or a single elongated ring forming an open slot) adapted to receive fingers of the user. One or a plurality of motors may be provided for driving a chain of cutting links that extends around the one or more loops. The chain path may circulate from the palm (where the chain is enclosed or protected from the user’s skin) around and passing the knuckles (where the chain may be exposed to the outside) and back to the palm. The motors and/or battery unit may be located in the palm or up the wrist and/or forearm for more volume and weapon stability.

Such a fist-held device provides the user the ability to simply enter the user’s fingers into the frame and wrap the user’s hand around the handle (e.g., housing the drive mechanism). The device may comprise one or more guards that can selectively cover or expose the chain around the outside of the user’s knuckles. In one example, the guards may extend and retract from opposite sides of the chain, coming to a closed position at a centerline above the chain (resembling a pair of lips). The handle may comprise on or more actuating triggers. For example, a single actuating trigger can actuate the guard(s) to expose the chain as well as activate the motor to drive the chain. The actuating trigger may be actuated by a squeezing motion. Thus, for example, by squeezing an actuating trigger on the handle, the user can actuate a set of guards that expose the sharp cutting links and actuate the motor and chain. Releasing the actuating trigger can stop the motor and close the guard(s). The motor could stop driving the links either passively or actively with a braking mechanism or a dynamic braking electronic circuitry. The mechanism may be spring-loaded with or without an extra safety mechanism to reduce the chance of unintended deployment and actuation. In this way, the user could have this device in the user’s pocket without the worry of cutting or damaging clothes or risking injury to the person, while also facilitating quick removal.

In other examples, a small chain saw may be mounted to other knives, similar to the way that a scope is mounted on top of a rifle. A small chain saw may similarly be mounted to other tools and devices.

In examples of tools disclosed herein, the tool may have one or more ports or windows to facilitate flushing of debris such as saw dust or other solids or liquids that accumulate from the cutting action. The ports or windows may be located in the handle, housing, knife blade, or other tool component.

In various examples, the chain saw may be in the form of a cartridge that can be removed and replaced. For example, in a hunting application, the cartridge may be changed in the field or prior to a new hunt.

The chain saws (saw bar, chain of links, drive cog assembly) of tools disclosed herein may be similar to those disclosed in U.S. Non-Provisional Pat. Application No. 17/443,646, filed Jul. 27, 2021, entitled “Chain Saws, Components for Chain Saws, and Systems for Operating Saws,” and International Application No. PCT/US2021/043433, filed Jul. 28, 2021, entitled “Chain Saws, Components for Chain Saws, and Systems for Operating Saws,” the disclosures of which are incorporated by reference herein in their entirety.

In some examples, the saw bar comprises a rail, and the links have grooves such that the links straddle the rail. The rail may have a projection and the grooves of the links may have notches accommodating the projection, whereby the projection prevents dislocation of the links off of the saw bar in a direction away from the path of the chain around the saw bar.

In some examples, the chain saw comprises saw bar and a plurality of links arranged in a chain around the saw bar, wherein a first link comprises a hook that engages a recess of a second link, thereby coupling the first link and the second link together and allowing the first and second link to articulate with respect to each other without decoupling as the chain is driven around the saw bar. The links may have one or more cutting teeth oriented such that a cutting action results in forces directed in a substantially vertical direction, i.e., normal to the path of the chain and into the saw bar. The links may have cutting teeth in the shape of cones or pyramids, including oblique pyramids. The links may have cutting teeth aligned along the lateral sides of the links. The peaks of the cutting teeth may be aligned along the lateral sides of the links. The cutting teeth along one lateral side may be staggered with respect to the cutting teeth along the opposite lateral side.

In some examples, a hard coating may be applied to the contact surface of the saw bar, i.e., the surface of the saw bar that contacts the links, and/or to the contact surface of the links, i.e., the surface of the links that contacts the saw bar. The hard coating reduces friction and heat generation. The hard coating may also reduce wear and can avoid the need for lubricants, which is beneficial in medical settings in which most lubricants would not be acceptable. The hard coating may be a diamond coating. Other example coatings include nitrides of titanium and titanium alloys as well as other materials, which may be applied by vapor deposition or other processes. A hard coating, such as a diamond coating or other coatings disclosed herein, can also be used to coat the cutting teeth of the links, for similar benefits with respect to reducing friction, heat, and wear. Lubricants may also be used and may be internal or automatically actuated by electronic or mechanical means, with or without a manual actuator.

In some examples, the links of the chain may be manufactured using: (i) metal injection molding to mold a link having a first lateral side, a second lateral side, and a plurality of cutting teeth, and (ii) grinding (e.g., double disc grinding) to grind the first lateral side and the second lateral side of the link.

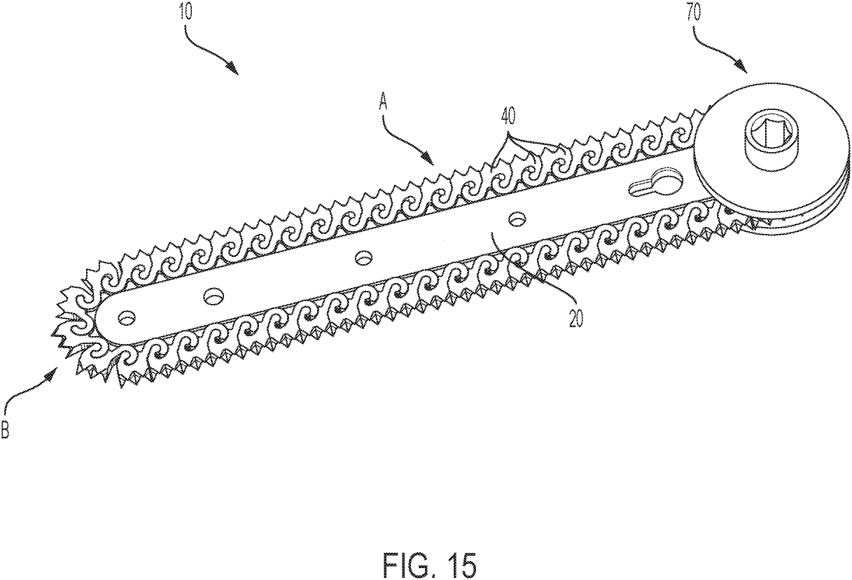

FIG. 15 shows a first example of a chain saw cartridge 10 suitable for use in a knife or other tool as disclosed herein. The chain saw cartridge 10 in FIG. 15 comprises a saw bar 20, a plurality of links 40 assembled together in a cutting chain around the bar 20, and a drive cog assembly 70.

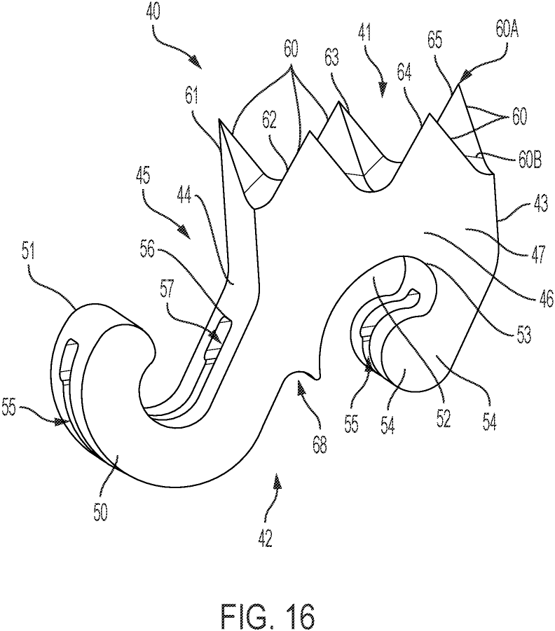

FIG. 16 shows a single link 40 for a cutting chain of a chain saw such as the cutting chain of chain saw cartridge 10 in FIG. 15. The link 40 comprises a top or cutting side 41, a bottom or bar side 42, a first adjacent link side 43, a second adjacent link side 44, a first lateral side 45, and a second lateral side 46.

The link 40 has a hook 50 and a recess 52. The link 40 has a rounded feature or projection 54 that defines one side of the recess 52. In this example embodiment, the hook 50 extends outward from the second adjacent link side 44 and upward from the bottom side 42, and the rounded projection 54 extends downward from the top side 41 and inward from the first adjacent link side 43. The recess 52 extends upward from the bottom side 42 and is shaped to receive a hook 50 of an adjacent link 40.

As shown in FIG. 15, a plurality of links 40 can be connected together in a chain to move along a predetermined path around the bar 20. The recess 52 of one link receives the hook 50 of an adjacent link, whereby the hook 50 fits into the recess 52. The hook 50 of one link thereby interlocks with the rounded projection 54 of an adjacent link. When two adjacent links are in an aligned or non-articulated configuration with one another, such as along a straight part A of the bar 20, the distance between the tip 51 of the hook 50 and the end 53 of the recess 52 leaves a clearance, allowing for articulation. When two adjacent links are in an articulated configuration along a convex path with one another, such as along a convexly curved part B of the bar 20, the articulation causes the hook 50 to engage further into the recess 52, and distance between the tip 51 of the hook 50 and the end 53 of the recess 52 is smaller than along the straight part A. In some embodiments, at the full extent of articulation, i.e., the maximum degree of pivot between adjacent links, the tip 51 of the hook 50 is at its closest point to, and in some embodiments may touch, the end 53 of the recess 52.

The configuration of the links 40 with the hooks 50 and corresponding recesses 52 allows the links 40 to pivot with respect to each other and to remain connected to each other even as they pivot away from each other along a convexly curved path. The links 40 remain connected, avoiding longitudinal disarticulation, without the need for separate connecting elements such as rivets, pins, or other connectors. Thus, the width of the chain is as thin as the width of the cutting links 40, allowing a thin chain, for a thin kerf.

As shown in FIG. 16, the bottom side 42 of the link 40 has a drive cog engagement recess 68. The drive cog engagement recess 68 is for engagement by a drive cog of a drive cog assembly (such as drive cog 138 of drive cog assembly 136).

At the top or cutting side 41, the link 40 has a plurality of cutting teeth 60. In the illustrated embodiment, each cutting tooth 60 is in the shape of a pyramid, tapering from a relatively wide base 60B to a sharp or relatively sharp peak or apex 60A. The illustrated teeth are arranged in two parallel rows, each running along a lateral side of the top side 41 of the link 40. Teeth 61, 63, and 65 are arranged along a first lateral side, and teeth 62 and 64 are arranged along a second lateral side.

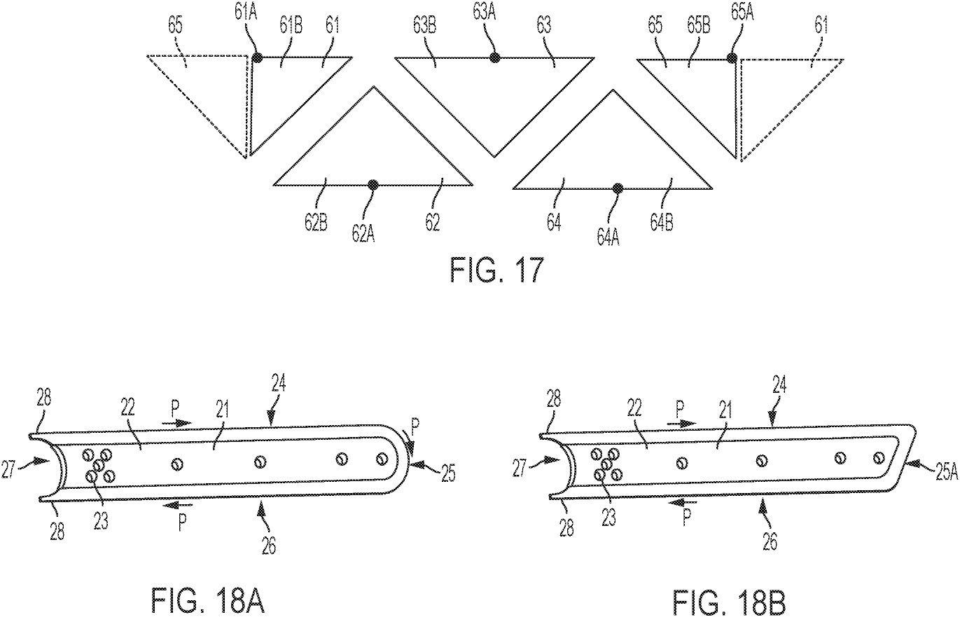

FIG. 17 shows a schematic view of the layout of the cutting teeth 60 of a link 40, showing in solid lines the bases 61B, 62B, 63B, 64B, and 65B of the teeth 61, 62, 63, 64, and 65, respectively. The bases 62B, 63B, 64B of teeth 62, 63, and 64 are triangular and have a first size. The bases 61B and 65B of teeth 61 and 65 are triangular and have a second size that is about half (a range that includes half and nearly half) of the first size. Each of the teeth 61, 62, 63, 64, and 65 is in the shape of an oblique pyramid, with the peak or apex of the pyramid located generally above the points labeled 61A, 62A, 63A, 64A, and 65A, respectively. One side of each pyramid is approximately coplanar or flush with a lateral side of the link 40. That is, each of teeth 61, 63, and 65 has a side that is approximately coplanar with a first lateral side 45 of the link 40, and each of teeth 62 and 64 has a side that is approximately coplanar with a second lateral side 46 of the link 40. In the illustrated embodiment, the peaks of the pyramidal teeth 61, 63, and 65, located generally above the points labeled 61A, 63A, and 65A, respectively, are aligned with the first lateral side 45 of the link 40, and the peaks of the pyramidal teeth 62 and 64, located generally above the points labeled 62A and 64A, respectively, are aligned with the second lateral side 46 of the link 40.

When the link 40 is arranged in a chain with similar links 40, the tooth 61 is adjacent a tooth 65, shown in dotted line, of an adjacent link, and together the adjacent teeth 61, 65 form a tooth profile similar to that of tooth 63. Similarly, when the link 40 is arranged in a chain with similar links 40, the tooth 65 is adjacent a tooth 61, shown in dotted line, of an adjacent link, and together the adjacent teeth 65, 61 form a tooth profile similar to that of tooth 63. In other words, a tooth 61 and an adjacent tooth 65 together form a tooth similar in size and shape to a tooth 63. Thus, when arranged in a chain of links, the chain has two rows of teeth, with teeth 62 and 64 alternating along one lateral side 46, and teeth 63 and 61/65 alternating along the other lateral side 45.

One result of this configuration is that the peaks of the teeth are at either side of the cutting surface with a valley in between. The cutting teeth on opposing sides are staggered such that a peak on one side lines up with a valley between peaks on the opposite side. This reduces the time between cutting impacts, thereby minimizing vibration, while allowing room for removal of debris. The shape and arrangement of the cutting teeth also promotes centering of the chain as it cuts. That is, the geometry and arrangement of the cutting teeth leads to self-centering of the links.

The links 40 can have approximately the same width as the saw bar. In such as case, with an arrangement with some pyramidal teeth having sides flush with a first lateral side 45 of the link 40 and other pyramidal teeth having sides flush with a second lateral side 46 of the link 40, the lateral side surfaces of the links (including the teeth) and the bar are continuous and relatively smooth. This aids in making cuts with a smooth surface.

The cutting width of the links may be equal to or greater than the width of the bar so that the saw does not bind up when encountering hard material such as bone. In some embodiments, such as the example illustrated in FIGS. 16 and 17, the pyramids or cutting elements are at the sides of the links and do not extend laterally beyond the width of the saw bar. In other examples, the pyramids or cutting elements may extend laterally beyond the sides of the links and/or laterally beyond the width of the saw bar.

The cutting teeth may have other shapes and arrangements. The teeth may be shaped as other types of cones, with a pyramidal shape being one example of a cone. A pyramid is a cone with a polygonal base. In the illustrated example, the base of the cone or pyramid is triangular, but other shaped bases may be used, having 4, 5, 6, 7, 8, or more sides. The polygons may have any suitable angle between sides. For example, if triangular bases are used, the triangles may have angles that are acute, 90 degrees, or obtuse. Example triangles have angles of 90 degrees, 45 degrees, and 45 degrees at their corners, or 60 degrees at each corner, or other suitable angle arrangements. Other shapes that the teeth may have include cones with circular, elliptical, or irregular bases. The cones may be right cones or oblique cones. For example, teeth shaped as pyramids may be right pyramids or oblique pyramids. Any edges, apices, or corners of the teeth may be sharp or rounded. The apices may be oriented vertically, or they may be tilted or curved inwardly and/or outwardly. Other shapes that the teeth may have include a concave shape with a cutting edge (like a spoon with a sharp edge) designed to scoop out material. For example, such a design may be used for scooping out volumes of soft material. A single link or single chain may have a mix of different sizes, heights, and shapes of cutting teeth, including any of the teeth described above.

The configuration of the cutting teeth as described, for example as shown in FIGS. 16 and 17, orients cutting edges of the teeth toward the material to be cut so that the cutting teeth act as cutting blades that facilitate slicing the material. This slicing function is in contrast to the chipping operation of conventional chisel-shaped teeth. Moreover, the arrangement of the cutting teeth with surfaces substantially coplanar with the lateral sides of the links facilitates cuts that have relatively flat and relatively smooth sides. In addition, the configuration of cutting teeth helps prevent clogging.

Arranging cutting teeth along lateral sides of the links with a valley in between gives room for removal of debris in the valley between the cutting teeth. The valley can also be used to advance fluids such as those used for lubricating, cooling, cleansing. Movement of the chain can also act as a conveyor in delivery of substances.

In some embodiments, it may be desirable to have one or more cutting elements in the center of the link, between the lateral rows of cutting elements along the sides. This may be desirable in order to cut between the lateral rows. Thus, in some embodiments, one or more links may have one or more center cutting elements, such as one or more chisel-shaped teeth or squared-off teeth. Such a cutting element or cutting elements do not need to be on every link. For example, half or a few or even only one link in a chain may have such a cutting element or cutting elements.

FIG. 18A shows a saw bar 21 that may be used in the chain saw cartridge 10. Saw bar 20 of FIG. 15 and saw bar 21 of FIG. 18A are similar except for having different holes 23 for fixing the bar 21 to the suspension system that attaches to the driving head of the chain saw. The saw bars 20, 21 are generally planar, with a main body 22 that contributes the primary strength and stability of the bar and allows the links to transmit a normal load with respect to the downward pressure of cutting, i.e., a load that is directed normal to the chain path and toward the saw bar. The bar has two sides 24, 26 in the longitudinal direction and a distal end 25 that in the embodiment of FIG. 18A is curved or semicircular. The bar has a recess at the proximal end 27, for accommodating a drive cog. The sides 24, 26 have extensions 28 that facilitate transfer of the continuous link chain from the bar to the drive cog and from the drive cog to the bar. The first longitudinal side 24, the second longitudinal side 26, and the distal end 25 define at least part of a chain path P around the saw bar 21.

The bar 20, 21 could have various other configurations. For example, the distal end 25 can be symmetrical and semicircular as shown in FIG. 18A, or it can have other shapes. In one alternative, as shown in FIG. 18B, the distal end 25A can be asymmetrical, presenting a sloped face with rounded ends that projects more on one side of the saw than the other. The sloped face may be relatively straight and angled with respect to a longitudinal axis of the saw bar such that one longitudinal side of the saw is longer than the other, and the sloped face may have rounded ends where it transitions to the longitudinal sides. Such a distal tip could be desirable in some applications.

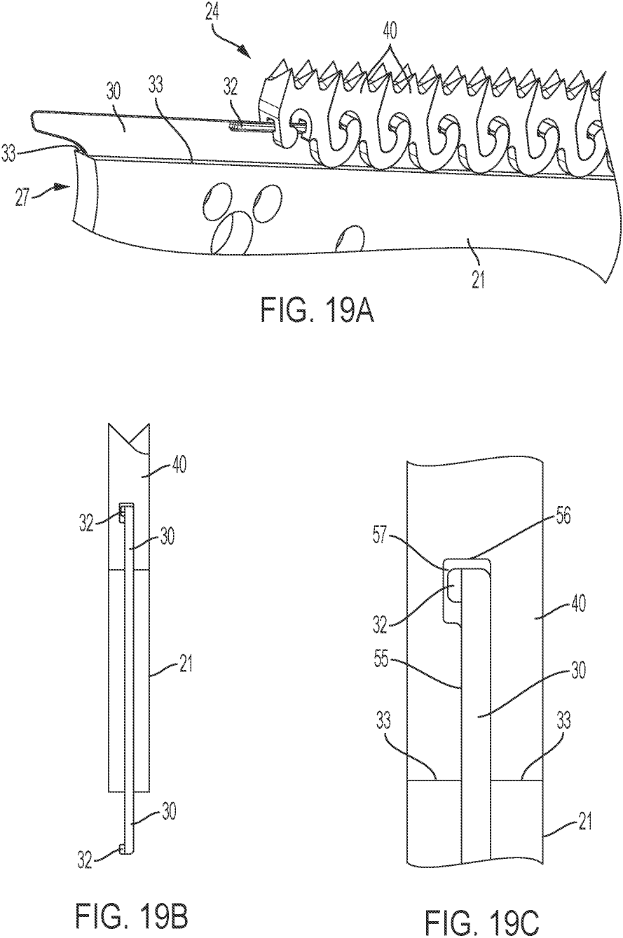

FIG. 19A shows an enlarged view of a first side 24 of the bar 21 at the proximal end 27 of the bar 21, with part of a chain of links 40 assembled on the bar 21, shown in a partial cut-away view. FIG. 19B shows an enlarged end view of the bar 21 at the distal end 25 of the bar 21, with a single link 40 shown for illustration purposes. FIG. 19C is an enlarged view of a portion of FIG. 19B.

As shown in FIGS. 19A, 19B, and 19C, the bar 21 has a rail 30 extending from the main body 22 of the bar 21. The rail 30 extends, in whole or in part, along the sides 24, 26 and the distal end 25 of the bar 21. The rail 30 acts as a monorail along which the links 40 of the chain travel. The rail 30 generally extends in a direction away from the main body 22 of the bar 21. The rail 30 includes a projection 32 that extends laterally beyond one or both sides of the rail 30. The projection 32 acts as a link lock or retention element that prevents the links 40 from coming off of the rail 30 in a direction away from the bar, i.e., in a direction away from the bar generally perpendicular to the direction of travel of the chain.

The links 40 have grooves in them so that the links 40 fit over and straddle the monorail 30. As shown in FIG. 16, the illustrated link 40 has a groove 55 that extends from the bottom side 42 of the link 40 upward part of the way to the top side 41 of the link 40. The top end of the groove 55 is labeled as top end 56. The groove 55 runs parallel to and is located between the first lateral side 45 and the second lateral side 46 of the link 40. The groove 55 extends the longitudinal length of the link 40, from the first adjacent link side 43 through the rounded projection 54 through the link body 47 and the second adjacent link side 44 and through the hook 50. The groove 55 includes a notch 57 that extends laterally beyond one or both sides of the groove 55. The notch 57 is shaped to accommodate the projection 32 of the rail 30.

As shown in FIG. 19C, the groove 55 and notch 57 of a link 40 accommodate the rail 30 and projection 32 of the bar 20, 21 to allow the links 40 to travel around the bar 20, 21 while preventing the links 40 from coming off of the rail 30 in a direction away from the bar 20, 21. In the illustrated example, when the links 40 are assembled on the rail 30, a clearance space is present between the top of the rail 30 and the top end 56 of the groove 55. In addition, in this example, a clearance space is present between the bottom of the notch 57 and the bottom of the projection 32. This allows some small movement or play of the links 40 in a direction away from the bar 20, 21 perpendicular to the direction of travel of the chain around the bar 20, 21. Also, in this example, the width of the groove 55 is slightly wider than the width of the rail 30. This allows some small movement or play of the links 40 in a lateral direction with respect to the bar 20, 21, while the rail 30 and groove 55 prevent any unwanted excessive movement of the links 40 in a lateral direction with respect to the bar 20, 21.

The clearance between the rail 30 and the groove 55 also results in the vertical load from the links 40, i.e., the load in a direction normal to the chain path directed into the saw bar, being taken up by the main body of the saw bar as opposed to the rail 30 itself. Vertical forces from the cutting pyramids of the links 40 are transmitted from the links 40 directly to the skids or ledges 33 of the saw bar on either side of the rail 30. The rail 30 itself is not loaded by these vertical forces. This arrangement tends to press the links 40 into place, while the rail 30 provides resistance to lateral movement or rocking motions of the links.

In other words, the ledges 33 are where the normal downward load from the links is primarily carried. The tangent sections at the bottom of the link 40, i.e., the tangent sections at the bottom of the hook 50 and the projection 54, contact the ledges 33 on either side of the rail 30. Because of the groove 56, the link 40 straddles the rail 30, with one side of the link 40 contacting the ledge 33 on one side of the rail 30 and the other side of the link 40 contacting the ledge 33 on the other side of the rail 30. The separation of the right link side to ledge contact and left link side to ledge contact provides inherent stability and planar control of the link with respect to the bar. The ledges 33 bear the downward forces from the links 40, resulting in stabilizing the links 40 and maintaining the links 40 in the same plane as the plane of the bar. This helps assure that the lateral sides of the links 40 remain substantially coplanar with the sides of the bar 20,21.

The projection 32 and notch 57 may take any suitable shapes for allowing the links 40 to travel around the bar 20, 21 while preventing the links 40 from coming off of the rail 30 in a direction away from the bar 20, 21. For example, the projection 32 may have a cross-sectional shape of a circle, oval, polygon, or irregular shape, and the notch 57 may have any suitable shape for accommodating the projection 32 while keeping the links 40 on the rail 30. The projection may be symmetrical or asymmetrical and may extend from one or both sides, and the notch similarly may be symmetrical or asymmetrical and may extend from one or both sides.

In an alternative embodiment, the rail 30 has a notch (like the notch 57) and the groove 56 of the links 40 have projections (like the projection 57) that fit in the notch. This alternative arrangement (switching the locations of the projection and notch) provides a similar link lock or retention element as described above, preventing the links 40 from coming off of the rail 30 in a direction away from the bar. The link locking feature on the saw bar, i.e., the projection or notch, may extend around the entire saw bar or only part(s) of the saw bar.

To mount the chain on the saw bar, the links may be coupled to each other. Then the end of the chain can be placed over the end of the rail 30, with the notch 57 of the end link 40 placed around the projection 32. Then the chain can be guided onto the rail 30 in the direction of the rail 30 and guided along the rail 30 around the saw bar 20, 21. The chain also fits around the drive cog and can be tensioned.

Tools and other devices with chain saws as disclosed herein can provide advantages in various fields, such as construction, landscaping, hunting, food processing, self-defense, and weaponry, among others. Examples of tools disclosed herein can provide versatile functionality, with the incorporation of chain saw cutting with other tool uses. Tools and other devices as disclosed herein can achieve one or more advantages, such as: reduced number of tools needed, lower cost, easier use, easier storage, easier transportation, less failure, more precise cuts, lower work time, and/or better outcomes.

Persons of ordinary skill in the art will appreciate that the embodiments encompassed by the disclosure are not limited to the particular example embodiments described above. While illustrative embodiments have been shown and described, a wide range of modification, change, and substitution is contemplated in the foregoing disclosure. It is understood that such variations may be made to the foregoing without departing from the scope of the disclosure.

What is claimed is:

1. A handheld tool comprising:
a handle comprising a housing;
a first tool component extending from the handle; and
a chain saw located at least partially within the first tool component, wherein the chain saw comprises:
(i) a saw bar; and
(ii) a plurality of links arranged in a chain along a chain path around the saw bar;
wherein the saw bar comprises a rail extending along at least part of the chain path around the saw bar; and
wherein each of the links in the plurality of links comprises a groove such that the links straddle the rail of the saw bar.

2. A handheld tool as recited in claim 1, wherein the handheld tool is a knife and the first tool component is a knife blade.

3. A handheld tool as recited in claim 1, wherein the handheld tool is an axe and the first tool component is an axe head.

4. A handheld tool as recited in claim 1, wherein the handheld tool is a hatchet and the first tool component is a hatchet head.

5. A handheld tool as recited in claim 1, wherein the handheld tool is a fist-held device and the first tool component is a set of rings adapted to receive fingers of a user.

6. A handheld tool comprising:
a handle comprising a housing;
a first tool component extending from the handle; and
a chain of cutting links;
wherein the tool further comprises a plurality of motors for driving the chain of cutting links.

7. A handheld tool as recited in claim 6, further comprising a saw bar;
wherein the chain of cutting links is positioned along a chain path around the saw bar;
wherein the saw bar comprises a rail extending along at least part of the chain path around the saw bar; and
wherein each of the cutting links in the chain of cutting links comprises a groove such that the cutting links straddle the rail of the saw bar.

8. A handheld tool as recited in claim 6, wherein the handheld tool is a knife and the first tool component is a knife blade.

9. A handheld tool as recited in claim 6, wherein the handheld tool is an axe and the first tool component is an axe head.

10. A handheld tool as recited in claim 6, wherein the handheld tool is a hatchet and the first tool component is a hatchet head.

11. A handheld tool as recited in claim 6, wherein the handheld tool is a fist-held device and the first tool component is a set of rings adapted to receive fingers of a user.

12. A handheld tool as recited in claim 6, wherein the plurality of motors are located in the handle.

13. A handheld tool comprising:
a handle comprising a housing;
a first tool component extending from the handle, wherein the first tool component comprises a cutting edge and a blunt edge;
a chain of cutting links; and
at least one motor for driving the chain of cutting links;
wherein the chain of cutting links is mounted to be driven along the blunt edge of the first tool component.

14. A handheld tool as recited in claim 13, further comprising a saw bar;
wherein the chain of cutting links is positioned along a chain path around the saw bar;
wherein the saw bar comprises a rail extending along at least part of the chain path around the saw bar; and
wherein each of the cutting links in the chain of cutting links comprises a groove such that the cutting links straddle the rail of the saw bar.

15. A handheld tool as recited in claim 13, wherein the handheld tool is a knife and the first tool component is a knife blade.

16. A handheld tool as recited in claim 13, wherein the handheld tool is an axe and the first tool component is an axe head.

17. A handheld tool as recited in claim 13, wherein the handheld tool is a hatchet and the first tool component is a hatchet head.

18. A handheld tool as recited in claim 13, wherein the handheld tool comprises a plurality of motors for driving the chain of cutting links and the plurality of motors are located in the handle.

19. A fist-held device comprising:
a handle comprising a housing adapted to be held in a fist of a user;
one or more loops adapted to receive fingers of the user;
a chain of cutting links; and
at least one motor for driving the chain of cutting links.

20. A fist-held device as recited in claim 19 wherein the chain of cutting links extends around the one or more loops.
